(19) United States
(12) Patent Application Publication
(10) Pub. No.: US 2019/0279316 A1
(43) Pub. Date: Sep. 12, 2019

(54) Home-based dine-in locations offering home-made food

(71) Applicant: Nisha Gupta, Audubon, PA (US)

(72) Inventor: Nisha Gupta, Audubon, PA (US)

(73) Assignee: Savera, Inc., Audubon, PA (US)

(21) Appl. No.: 15/914,575

(22) Filed: Mar. 7, 2018

(51) Int. Cl. G06Q 50/12; G06Q 30/06; G06Q 20/28

(52) U.S. Cl. CPC G06Q 50/12; G06Q 20/28; G06Q 30/0603

(57) ABSTRACT

This invention includes computer-based methods that allow a Guest (customer) to find nearby home-based dine-in locations offering reasonably priced home-made food of different cuisines, and allow a Host (stay-home person) to offer food to a Guest at Host's home and earn revenue from home without opening a commercial business. The method allows the Guest, while making payment to the Host, to also make donation of a portion of the payment to the charities of Guest's choice to support the “Remove Hunger from Earth” campaign; utilization of this method will aid in eliminating hunger from earth.

### FIELD OF THE INVENTION

This invention relates to computer-based method that will allow, a Guest (customer) to find nearby home-based dine-in locations offering reasonably priced home-made food of different cuisines; a Host (stay-home person) to offer home-made food to a Guest at Host's home and earn revenue without opening a commercial business; and the Guest, while making payment to the Host, to also make donation of a portion of the payment to a charity of Guest's choice to support the “Remove Hunger from Earth” campaign.

### DESCRIPTION OF THE RELATED ART

The current websites such as “Yelp” and “Open Table”, allow users to make reservations in advance at commercial dine-in restaurants near the Guest-selected locations. These websites allow users to post their reviews based on the quality of food and service received by them at the restaurants. The five-stars-rating-method and recommendations assist users to pick a restaurant that meets his/her requirements. These websites also allow restaurant owners to post information about their restaurants including menus with prices, and accompanying pictures of the food.

### SUMMARY

An embodiment of the present invention pertains to a computer-based method for anyone wanting food, herein referred as a “Guest”, to search for a reasonably priced home-made food of Guest's choice available at a home based dine-in location. The options that will result from the search, will allow the Guest to experience an authentic cuisine offered by a Host at Host's home.

Another embodiment of the present invention relates to a computer-based method for a stay-home person, herein referred as a “Host” to offer home-made food to a Guest at Host's home in exchange of money.

The computer-based method includes allowing the Host to use Host's home as the dine-in place for the Guest, and to offer food to the Guest that Host normally prepares for himself/herself or his/her family in daily life, thereby will allow the Host to offer healthier and cheaper food options to the Guest than a commercial fast food/dine-in restaurant.

The computer-based method further includes allowing the Host, who is a stay-home person and cannot afford to start a business, to earn revenue from home by serving home-made food to Guests at Host's home.

Yet another embodiment of the present invention pertains to a computer-based method for the Guest, while making payment to the Host, to also make donation of a portion of the payment to a charity of Guest's choice to support the “Remove Hunger from Earth” campaign.

### BRIEF DESCRIPTION OF THE DRAWINGS

FIG. 1 shows the website that will be named “Home Food For You” (HFFU) with the domain “www.HFFU.com” (subject to change depending on availability of the domain). The website will provide a common platform to all concerned parties which includes a Guest looking for food and specifically home-made food, a Host who can offer home-made food at Host's home, and various Charities that support “Remove Hunger from Earth” Campaign.

FIG. 2 shows the homepage of the HFFU website that will be accessible to all concerned parties including the Guest, the Host, and the various Charities. The Guest will be able to start the search for food options by entering his/her location, and based on Guest's location, the website will populate various choices of the home-made food available near the Guest's location. The homepage will have a menu specific for the Guest, that will enable the Guest to either create an account before ordering the food, or order food without creating an account. If the Guest decides to create an account, then the information that Guest will enter (such as the name, location, mode o payment, food choice, past orders) will be stored in his/her account to expedite future orders. The homepage will also include menu for the Host for enabling the Host to create an account, upload the information about different foods offerings, prices, address of the location, pictures of the food, and pictures of the place where food will be served. Both the Guest and the Host will also be able to directly access their accounts through the Log-In menu by entering their specific information (name and password). Additionally, there will be a menu that will allow the Guest to gain information about the “Remove Hunger from Earth” campaign and the charities that support this campaign. Guest will be able to join the campaign by donating an amount to a charity of choice while making payment to the Host. The homepage will also have various menus to provide the Guest and the Host with the information pertaining to the HFFU website administrative staff, physical address, Help-line, Career opportunities, News, Social media links, and the HFFU Policy, Copyright, Site map.

FIG. 3 illustrates the Guest menu (101) showing how a Guest would gain access to different dining options by selecting the location and, the cuisine and meal type.

FIG. 4 is a flow diagram illustrating the process of interaction between the Guest and the Host. It shows that when a Guest requests reservation with a Host, an email and/or instant message (IM) is sent to the Host for confirmation. If Host accepts the Guest, then Guest gets acceptance notification via email and/or IM following which the payment page appears which allows the Guest to make the payment. While making the payment Guest can also select the option for Y% donation to the charity of his/her choice. The HFFU company will keep X% of the payment for administration, and pays Y% to the charity chosen by the Guest and Z% to the Host. If the Host denies and does not accept the Guest, then the reservation with that Host will be deleted and other Host available in the area offering food of Guest's choice will populate the Guest's screen. The process will repeat again until a Host accepts the Guest or until the Guest decides to stop searching for food.

FIG. 5 depicts the menu for the Host showing how a Host will create a profile by uploading personal information, and information about his/her home-made food offerings including the type of cuisine, meal, description of the food, pictures of the food, dining facility, and bank information to receive the payment; it also shows how the Host will receive payment from the HFFU website.

FIG. 6 illustrates the Log-in menu for both the Host and the Guest; it shows how the Host and the Guest accounts will be created and their information will be saved in their respective accounts.

FIG. 7 illustrates the details of the menu for the “Remove Hunger from Earth” campaign, which includes the list of the charities that supports the campaign; when a Guest selects the charity of his/her choice, the HFFU website will pay Y% amount to the Guest selected charity (from the X% amount paid by the Guest as the total payment).

FIG. 8 depicts the accounting method for the HFFU website. HFFU website will use a secured third-party merchant cards facility. This will connect the HFFU bank account, Guest payment, Host bank account, and Charities' bank accounts.

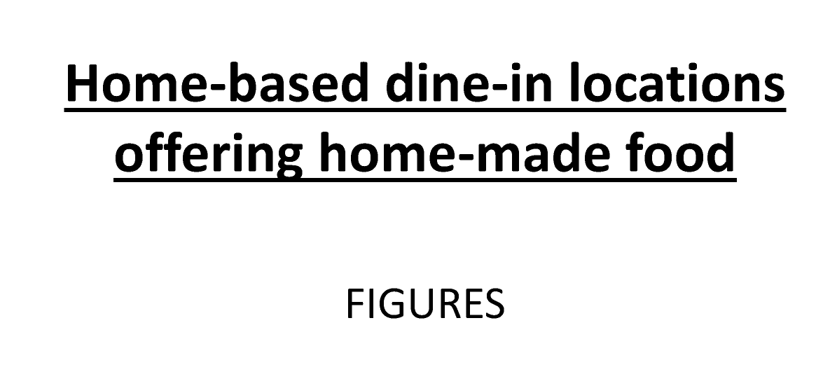

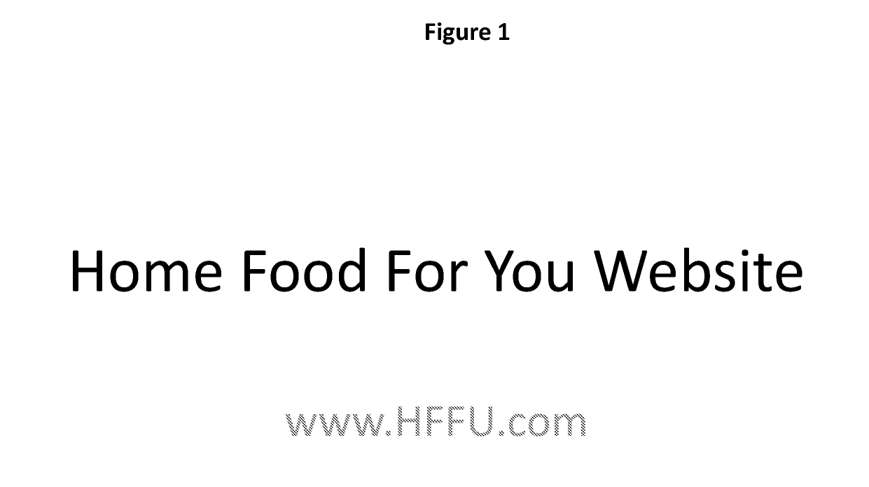

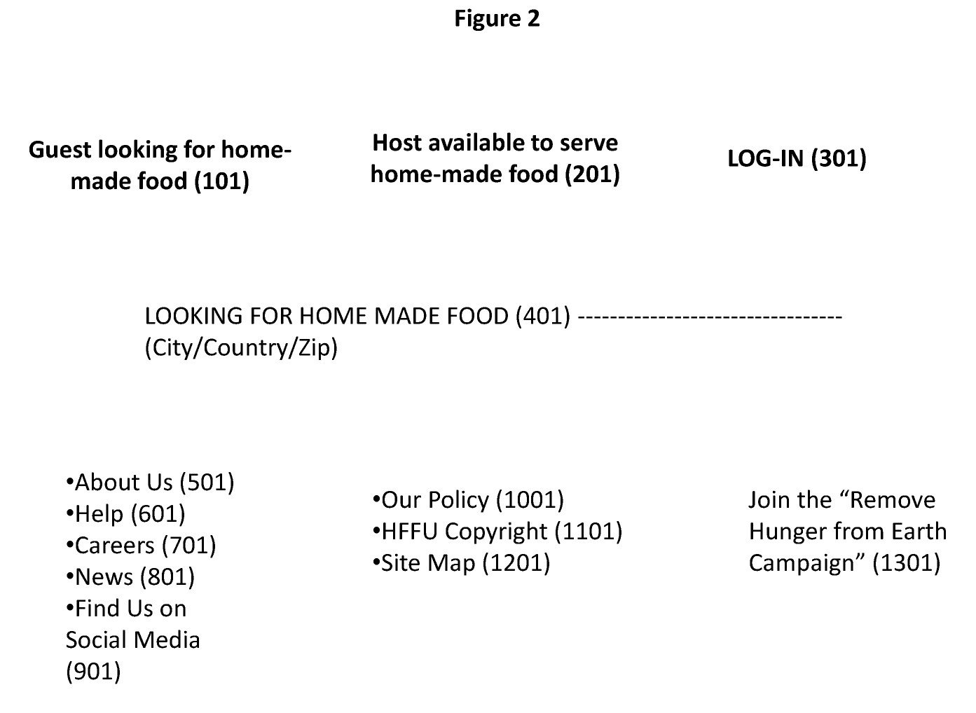

### DETAILED DESCRIPTION

Individuals who may be young, single, living without a family and/or who do not wish to cook food at home on daily basis, look for cheaper and healthier food options available for purchase at nearby locations. At present, there are many websites which serves the need of such individuals by providing with the options of food that's prepared and served at commercial fast food or dine-in restaurants. However, the food options available through these websites for individuals who are seeking food on daily basis may not be the most economical and healthiest options.

An embodiment of this invention includes a computer-based method in the form of a website, “Home Food for You (HFFU)”, that will allow a Guest (customer) from any parts of the world to find nearby home-based dine-in location offering reasonably priced home-made food of different cuisines.

This computer-based method further includes allowing the Guest to find nearby options for experiencing reasonably priced authentic home-made food of different cuisine in a home-based environment.

Guest will enter the location where he/she wants to experience the home-made food on the HFFU website and the website will populate the list of Hosts offering home-made food at their home near the Guest's location; the website will also enable the Guest to narrow the search for Hosts by entering type of cuisine, price range, and reviews from past guests.

Another embodiment of the invention includes a computer-based method, in the form of a website for a Host who desires to offer home-made food from his/her home to a Guest and earn some money.

The Host will be able to offer more economical and healthier food options to a Guest then a commercial restaurant because of two reasons. Firstly, the Host will be using her/his own home as the place to serve food to the Guest rather than a commercial space; secondly, Host will be offering food that she/he normally prepares for feeding herself/himself or her/his family so will be mindful in using healthy and reasonably priced ingredients.

Yet another embodiment of the present invention includes a computer-based method for allowing the Guest, while making payment to the Host, to also make donation of a portion of the payment to a charity of Guest's choice to support the “Remove Hunger from Earth” campaign.

The HFFU website will identify and screen the charities, and make them available to the Guest for selection and while making payment to the Host, to also donate a portion of the payment to the selected charity.

The HFFU website will have all modules linked to its homepage. Module 101 is for the Guest, the source of revenue. Module 101 will have the Guest information such as his/her name, address, payment information, order history, and a picture for identification. New Guests will also be able to open their accounts in Module 101.

Module 201 will have information about the Host that will include Host's name and address, pictures of the food offered, picture of the dining facility, menu including price information, bank account information for accepting payments, history of food sold, and previous customer reviews. The Host will initially set-up the account in this module. After this initial set-up, the Host will be able to login into the account either using module 201 or directly from Log-In module 301. Host will also pay the taxes on earnings based on the jurisdiction of the Host's location.

Module 301 will allow both the Guest and Host to login to their accounts and edit details as required.

Module 401 will allow the Guest to browse the food options by entering the location, where he/she would like to eat. If the location feature is enabled on the device (such as computer, phone) that Guest is using, then that the Guest's location will automatically be populated in the location field. Based on the Guest's location, the HFFU website will populate the food choices offered by the Hosts near that location. This will help the Guest in case if he/she is unaware of his/her location.

Module 501 will provide details about the HFFU website such as the vision, the goal, and the team involved with the HFFU website.

The module 601 will list different options for getting help with the website, listing the telephone number and email address. Frequently Asked Questions (FAQ) will be also included in this module.

Any job opportunities with the HFFU team will be detailed in module 701. Note, the HFFU will be an Equal Opportunity Employer.

The module 801 will include relevant announcements, latest and past news, press releases about the HFFU website and its team. This section will be kept up-to-date.

The HFFU website will be marketed mainly through social media. The HFFU website profile will be created on various social networking websites. The module 901 will provide links to the HFFU profiles on social media.

The website's terms and policies related to the Guest and Host accounts, payments, technical issues, resolution to the issues, privacy, HFFU service fee, and donations to charities will be detailed in module 1001.

The HFFU copyright policy will be included in module 1101.

The Site Map in module 1201 will provide links to all HFFU web pages from one location.

One of the main goals of HFFU website is to promote and donate to those charities which support the “Remove Hunger from Earth” campaign. The HFFU team will shortlist such charitable organizations and provide links to their websites in module 1301. These charities will populate Guest's screen when the Guest is ready to place an order with a Host. The HFFU team will monitor the charities to make sure that the Guest's donations are properly used.

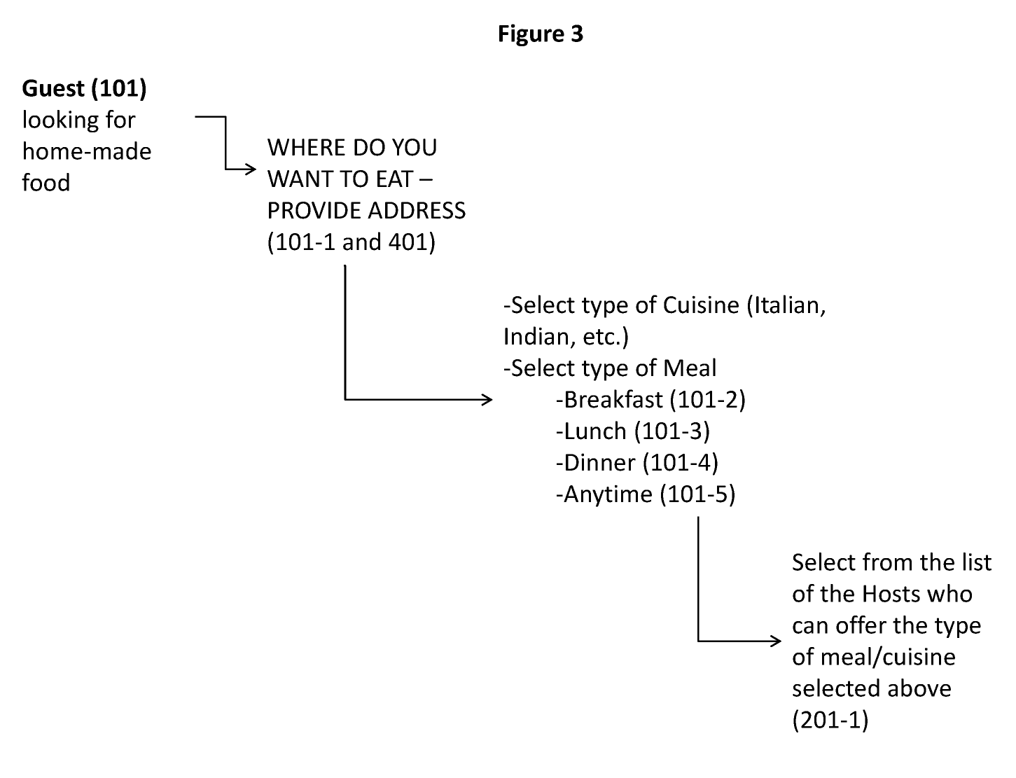

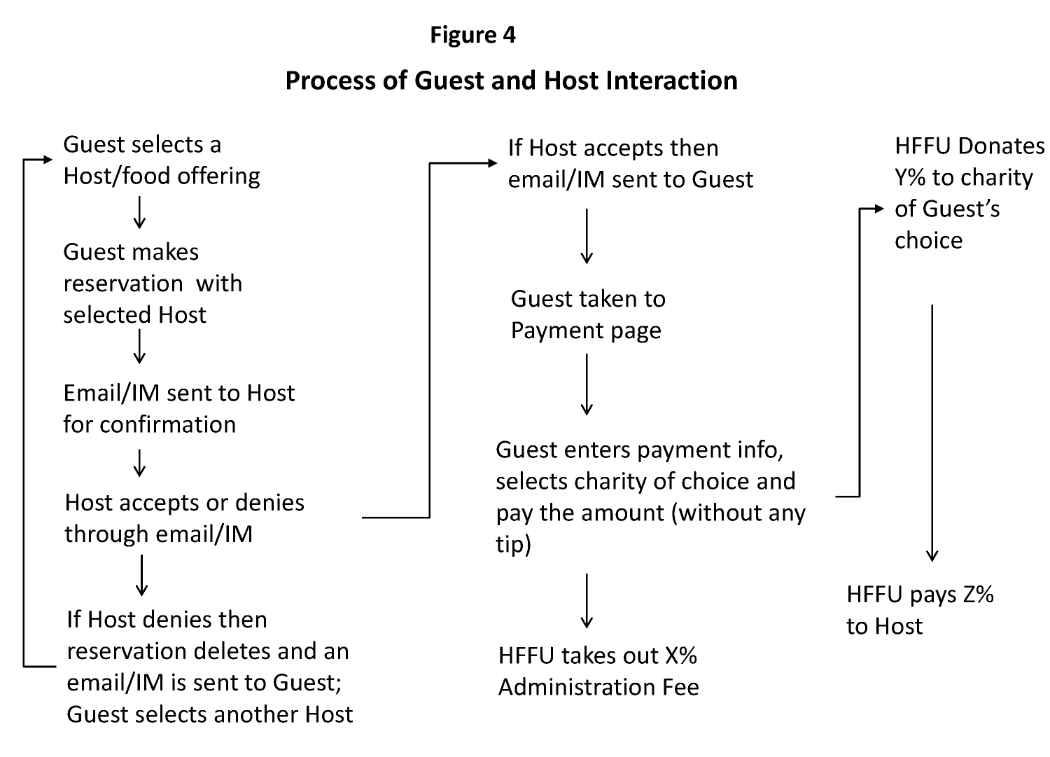

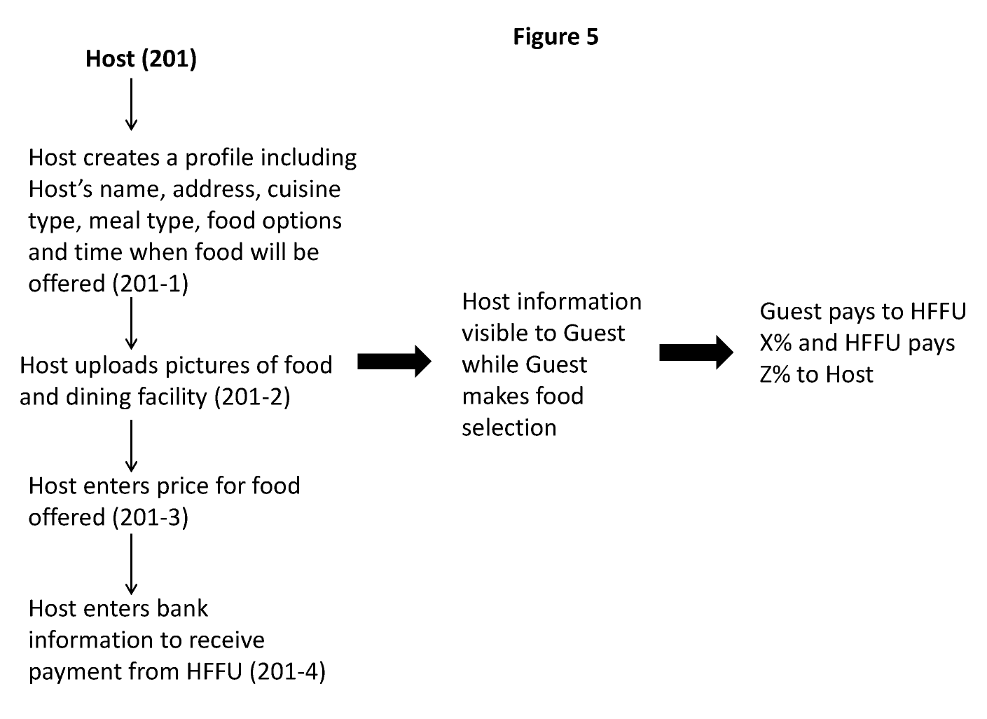

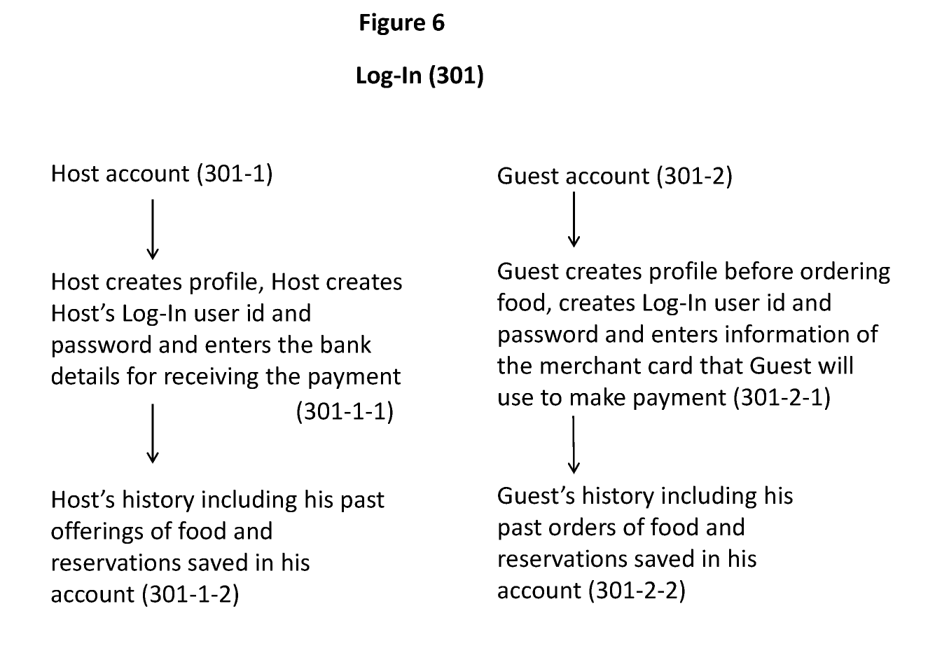

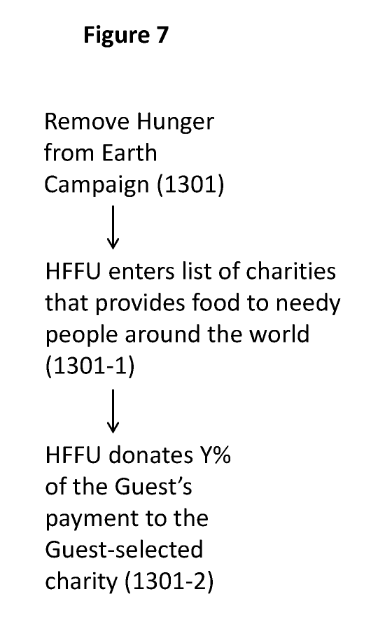

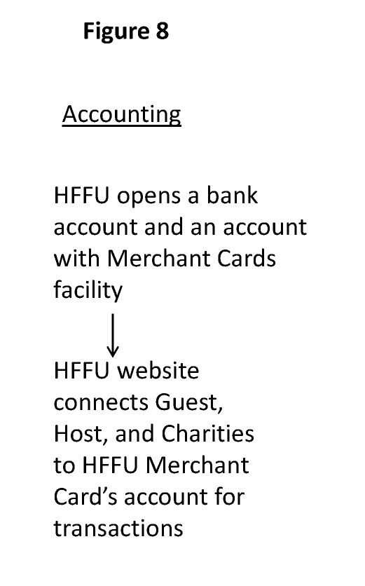

FIGS. 3 through 8 show flow charts with processes followed in the various modules described above.

1. A computer-based method that allows a Guest (customer) to find home-based dine-in location (Host) offering reasonably priced home-made food of different cuisines.

2. The computer-based method in claim 1 which allows a Guest from any parts of the world to search for reasonably priced home-made food of his/her choice.

3. The computer-based method in claim 1 which allows a Guest from any parts of the world to search for reasonably priced home-made food of choice closer to Guest's location.

4. The computer-based method in claim 1 which allows a Guest from any parts of the world to experience an authentic cuisine at a home based dine-in location.

5. The computer-based method in claim 1 which allows a Guest from any parts of the world to be able to choose any type of meal options with any number of courses from an authentic cuisine.

6. The computer-based method in claim 5 allows a Guest from any parts of the world to be able to choose any type of meal options including but not limited to breakfast, lunch, dinner or snack, and each meal comprising of any number of courses consisting of but not limited to a soup, an appetizer, a salad, a main entre, a bread, a curry, and a dessert.

7. The computer-based method in claim 1 which allows a Guest from any parts of the world to make advance payment to a nearby home-based dine-in location (Host) in exchange of reasonably priced home-made food.

8. The computer-based method which allows the Guest in claim 7, while making the advance payment to the nearby home-based dine-in location, to also select charities associated with the “Remove Hunger from Earth” campaign and donate to the selected charity a certain amount of the advance payment.

9. A computer-based method that allows a Host from any parts of the world to offer home-made food to a Guest at Host's home in exchange of money.

10. The computer-based method in claim 9 which allows a Host from any parts of the world to offer variety of home-made food at reasonable prices.

11. The computer-based method in claim 9 which allows a Host from any parts of the world to be able to offer any type of meal with any number of courses from an authentic cuisine.

12. The computer-based method in claim 11 allows a Host from any parts of the world to offer any type of meal including but not limited to breakfast, lunch, dinner or snack, and each meal comprising of any number of courses consisting of but not limited to a soup, an appetizer, a salad, a main dish, a bread, and a dessert.

13. The computer-based method in claim 9 which allows a Host from any parts of the world to earn revenue by offering home-made food to a Guest at Host's home.

14. The computer-based method in claim 9 which allows a Host from any parts of the world to earn revenue without opening a commercial business by offering home- made food to a Guest at Host's home.

15. The computer-based method in claim 9 which allows a Host from any parts of the world to do business at a minimal cost by offering home-made food to a Guest at Host's home.

16. The Host in claim 9 is a person who cannot afford or willing to start a commercial business.

17. The Host in claim 16 is a person who can be a stay-home person, home maker, house wife, a stay-home person with physical disability, a stay-home retired person, a stay-home senior, or a stay-home person who is self-employed.

18. The computer-based method which allows the Host in claim 9 to accept the advance payment from a Guest (customer) in exchange of serving home-made food to the Guest at Host's home.
